(19) United States
(12) Patent Application Publication
(10) Pub. No.: US 2008/0205297 A1
(43) Pub. Date: Aug. 28, 2008

(54) IP MULTICAST DELIVERY APPARATUS, CONTENT DELIVERY SYSTEM, AND IP MULTICAST DELIVERY METHOD BEING EMPLOYED THEREFOR

(76) Inventors: Sadao KIMURA, Tokyo (JP); Sou SATOU, Tokyo (JP)

Correspondence Address: NEC CORPORATION OF AMERICA, 6535 N. STATE HWY 161, IRVING, TX, 75039, US

(21) Appl. No.: 12/033,443

(22) Filed: Feb. 19, 2008

(30) Foreign Application Priority Data
Feb. 28, 2007 (JP) JP2007-048272

(51) Int. Cl. H04L 12/28

(52) U.S. Cl. 370/254

(57) ABSTRACT

The present invention is an IP multicast delivery apparatus for relaying the content, which is delivered from the multicast delivery server with the IP (Internet Protocol) multicast, to the premise apparatus, comprising: managing unit for managing a dependence relation of the content between the multicast groups; and controller for stopping/restarting of transfer of a multicast group based on the dependence relation that is managed by said managing unit.

### INCORPORATION BY REFERENCE

This application is based upon and claims the benefit of priority from Japanese patent application No. 2007-048272, filed on Feb. 28, 2007, the disclosure of which is incorporated herein in its entirety by reference.

### RELATED ART

The present invention relates to an IP multicast delivery apparatus, a content delivery system, and an IP multicast delivery method that is employed therefor, and more particularly to a content delivery with an IP (Internet Protocol) multicast.

A typical configuration of the content delivery with the IP multicast is shown in FIG. 7. In FIG. 7, a network of the IP multicast is comprised of premise apparatuses (#1 to #3) 5a to 5c each of which is installed in a customer's house, a multicast delivery server 6a (hereinafter, referred to as a delivery server) for storing content such as a video and yet making a public delivery thereof arranged in a CDN (Content Delivery Network) 210a, and a relay apparatus 4 that is configured of a router, a line concentrator, and so on in a relay network 200 arranged between both of the premise apparatuses (#1 to #3) 5a to 5c and the delivery server 6a.

Each of the premise apparatuses (#1 to #3) 5a to 5c transmits a request for participation in a multicast group according to a user's request etc. for making a switchover of a channel. The relay apparatus 4 transmits a multicast traffic transmitted by the delivery server 6a to the premise apparatuses (#1 to #3) 5a to 5c based upon a request for participation in a group by the premise apparatuses (#1 to #3) 5a to 5c, thereby enabling viewing or listening to digital content.

The relay apparatus 4 that is arranged in the relay network 200 determines a physical port to which a corresponding multicast packet has to be transferred as a result of a request for participation in a group by the premise apparatuses (#1 to #3) 5a to 5c. The relay apparatus 4 copies/transfers the multicast packet, which is transmitted from the delivery server 6a, to an appropriate port according to a multicast transfer table formed in such a manner.

With regard to the content delivery with the IP multicast of this type, there exist the technologies listed in JP-P2003-258892A, JP-P2005-229465A, and JP-P2003-236701A.

The foregoing relay apparatus, which is nothing but an apparatus that appropriately copies/transfers the packet from the delivery server, cannot notify the effect that an upstream network or the delivery server has failed to the premise apparatus even in a situation where the packet from the delivery server does not arrive although the premise apparatus receiving certain content exists.

Further, as shown in FIG. 8, the foregoing relay apparatus, which transmits to the premise apparatuses (#1 to #3) 5a to 5c an emergency notification broadcast as a packet in parallel to the multicast group established in a fixed manner at the time of occurrence of a disaster, causes the problem that two traffics (a multicast packet and an emergency notification packet) of the multicast group simultaneously arrive at each of the premise apparatuses (#1 to #3) 5a to 5c, and resultantly, the content cannot be reproduced correctly because the emergency notification packet is delivered simultaneously with the packet that is currently being received by the premise apparatus.

In addition hereto, in this case, the foregoing relay apparatus causes the problem that a designed network band is exceeded and the band of other packet is oppressed because the packet for emergency notification and the multicast packet corresponding to the content that is currently being received are transferred to the network in the premise apparatus side.

Further, each multicast group is treated as an independent traffic in the conventional network, whereby the following problems exist.

(1) In a case of delivering the emergency notification broadcast etc., video data cannot be reproduced correctly because the emergency notification traffic and the normal multicast traffic are transmitted to the premise apparatus.

(2) A line band is oppressed because the emergency notification traffic and the normal traffic are simultaneously transmitted.

(3) In a case where a failure of the delivery server, or the network in the delivery server side occurs, the failure of the upstream network cannot be notified to the premise apparatus.

### SUMMARY OF THE INVENTION

An exemplary object of the present invention is to solve the above-mentioned problems.

Further, another exemplary object of the present invention is to provide an IP multicast delivery apparatus, a content delivery system, and an IP multicast delivery method being employed therefor, which make it possible to receive only the traffic appropriate as a traffic that the premise apparatus should receive, out of a plurality of multicast traffics receivable in the premise apparatus that are being delivered, and to correctly reproduce the traffic in the premise apparatus.

The present invention for accomplishing the above-mentioned object of the present invention, which is an IP multicast delivery apparatus for relaying the content, which is delivered from the multicast delivery server with the IP (Internet Protocol) multicast, to the premise apparatus, comprising: managing unit for managing a dependence relation of the content between the multicast groups; and controller for stopping/restarting of transfer of a multicast group based on the dependence relation that is managed by said managing unit.

The present invention for accomplishing the above-mentioned object of the present invention, which is an IP multicast delivery system for relaying the content, which is delivered from the multicast delivery server with the IP (Internet Protocol) multicast, to the premise apparatus, comprising: managing unit for managing a dependence relation of the content between the multicast groups; and controller for stopping/restarting of transfer of a multicast group based on the dependence relation that is managed by said managing unit.

The present invention for accomplishing the above-mentioned object of the present invention, which is an IP multicast delivery method for relaying the content, which is delivered from the multicast delivery server with the IP (Internet Protocol) multicast, to the premise apparatus, comprising the steps of: managing process for managing a dependence relation of the content between the multicast groups; and controlling process for stopping/restarting of transfer of a multicast group based on said dependence relation that is managed.

In the present invention, by assuming the configuration and operation as mentioned above, the effect that only the traffic appropriate as a traffic that the premise apparatus should receive, out of a plurality of the multicast traffics receivable in the premise apparatus that are being delivered, can be delivered, and the traffic can be correctly reproduced in the premise apparatus is obtained.

### BRIEF DESCRIPTION OF THE DRAWINGS

This and other objects, features and advantages of the present invention will become more apparent upon a reading of the following detailed description and drawings, in which:

FIG. 1 is a block diagram illustrating a configuration example of the IP multicast delivery apparatus in accordance with an exemplary embodiment of the present invention;

FIG. 2 is a view illustrating an operation example of the IP multicast delivery apparatus in accordance with the exemplary embodiment of the present invention;

FIG. 3 is a view illustrating an operation example of the IP multicast delivery apparatus in accordance with the exemplary embodiment of the present invention;

FIG. 4 is a block diagram illustrating a configuration of the content delivery system in accordance with one exemplary example of the present invention;

FIG. 5 is a view illustrating an outline of an operation of the packet in the IP multicast delivery apparatus shown in FIG. 4;

FIG. 6 is a view illustrating an outline of an operation of the packet in the IP multicast delivery apparatus in accordance with another exemplary example of the present invention;

FIG. 7 is a block diagram illustrating a configuration example of the related content delivery system; and

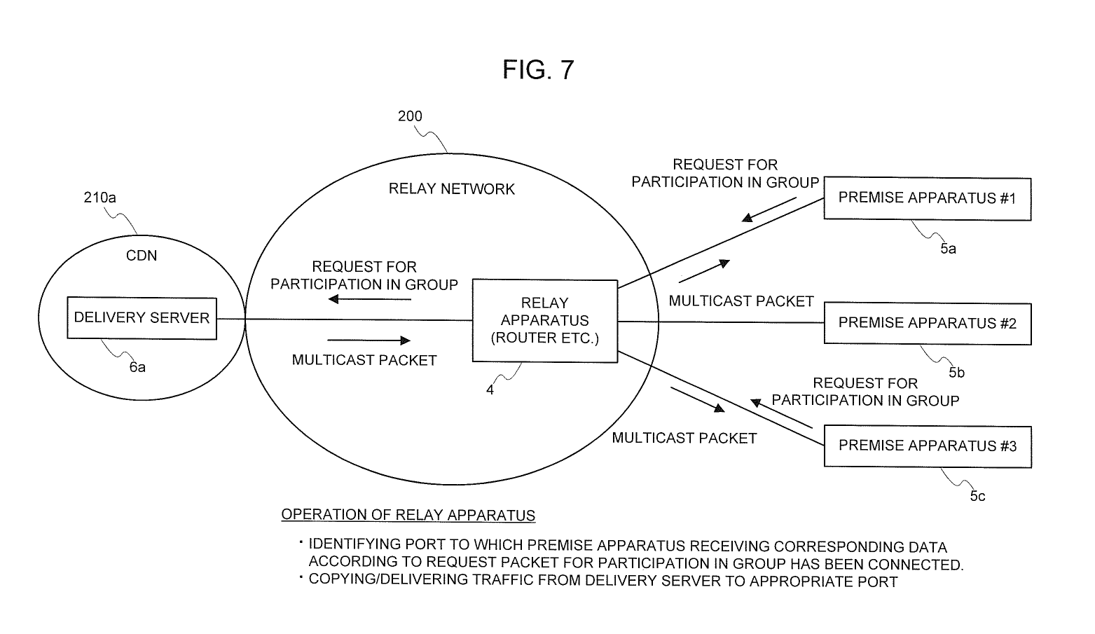

FIG. 8 is a block diagram illustrating an operation example of the related content delivery system.

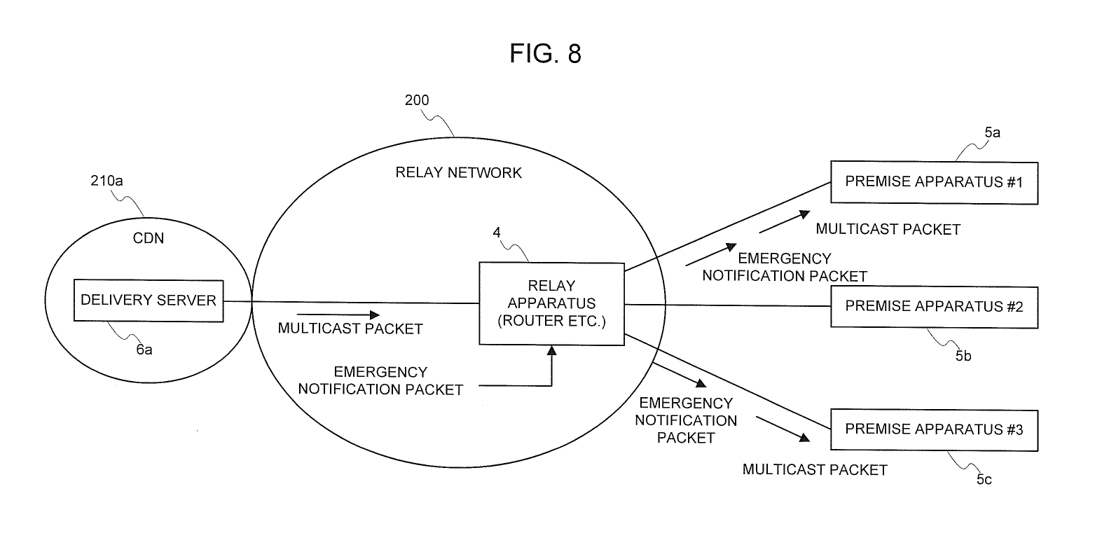

### EXEMPLARY EMBODIMENTS

Characteristics of the present invention will be explained.

The IP multicast delivery apparatus in accordance with the present invention, which is an IP multicast delivery apparatus for relaying the content, which is delivered from the multicast delivery server with the IP (Internet Protocol) multicast, to the premise apparatus, includes a managing unit for managing a dependence relation of the content between the multicast groups, and a unit for, based upon presence or absence of a specific multicast group pre-set based upon the dependence relation that is managed by the managing unit, controlling stopping/restarting of transfer of the other multicast groups.

The content delivery system in accordance with the present invention is characterized in including the above-mentioned IP multicast delivery apparatus.

In the IP multicast delivery method in accordance with the present invention, which is an IP multicast delivery method that is employed for the relay apparatus for relaying to the premise apparatus the content being delivered from the multicast delivery server with the IP (Internet Protocol) multicast, a managing process in which the relay apparatus manages a dependence relation of the content between the multicast groups, and a process of, based upon presence or absence of a specific multicast group pre-set based upon the dependence relation that is managed in the managing process, controlling stopping/restarting of transfer of the other multicast groups are executed.

That is, the content delivery system of the present invention is characterized in managing a dependence relation between the multicast groups, and based upon presence or absence of a certain multicast group, controlling stopping/restarting of transfer of the other multicast groups.

The IP multicast delivery apparatus of the present invention is configured of an input detector for detecting a regular input of the traffic, a timer mechanism, a queue for storing the packet, and a traffic selector for selecting the traffic that is stored into the queue as a basic configuration. Each queue, as a rule, has a shaping function etc. of delivering the traffic in an appropriate band in some cases.

It is assumed that the traffic selector performs an operation of selecting one multicast traffic from among a plurality of the multicast traffics that were input, or selecting none of them, that is, storing no multicast traffic into the queue.

Herein, the IP multicast delivery apparatus of the present invention has a mask table of the multicast traffics. The mask table is defined as data of a plane having a longitudinal axis and a traverse axis, in which the multicast group being masked by a certain multicast group is expressed as a bit map. For example, into the mask table is stored data having the content saying that when the traffic of a multicast group McastA is input, the traffics of McastL and McastM are masked.

When the input detector and the timer mechanism detect a stabilized input of the traffic, the IP multicast delivery apparatus of the present invention determines the multicast traffic being masked by the traffic that was input with the mask table. Storing of the traffic being masked in this determination is stopped in the traffic selector.

Further, contrarily hereto, when the input of the multicast traffic cannot be detected for a constant time, the IP multicast delivery apparatus of the present invention makes a switchover of the traffic selector masked by the corresponding multicast group under control of the mask table, and restarts storing of the traffic into the queue.

With this, in the content delivery system of the present invention, based upon presence or absence of a multicast packet being input into the IP multicast delivery apparatus, it becomes possible to stop/restart delivery of the other multicast traffics.

Thus, in the content delivery system of the present invention, by managing a relation between the multicast groups in the router or the line concentrator that is arranged in the relay network, the normal multicast traffic, which is to be delivered to the corresponding area, is stopped due to the emergency notification traffic, whereby the multicast traffic being delivered to the premise apparatus is only a traffic for emergency notification, which enables this emergency notification to be correctly reproduced by the premise apparatus.

Further, in the content delivery system of the present invention, the possibility that other traffic is oppressed is eliminated because a delivery of the normal packet to the corresponding area is stopped due to the emergency notification traffic.

In the present invention, by assuming the configuration and operation as mentioned above, the effect that only the traffic appropriate as a traffic that the premise apparatus should receive, out of a plurality of the multicast traffics receivable in the premise apparatus that are being delivered, can be delivered, and the traffic can be correctly reproduced in the premise apparatus is obtained.

Hereinafter, the exemplary embodiment of the present invention will be explained.

Next, the exemplary embodiment of the present invention will be explained by making a reference to the accompanied drawings.

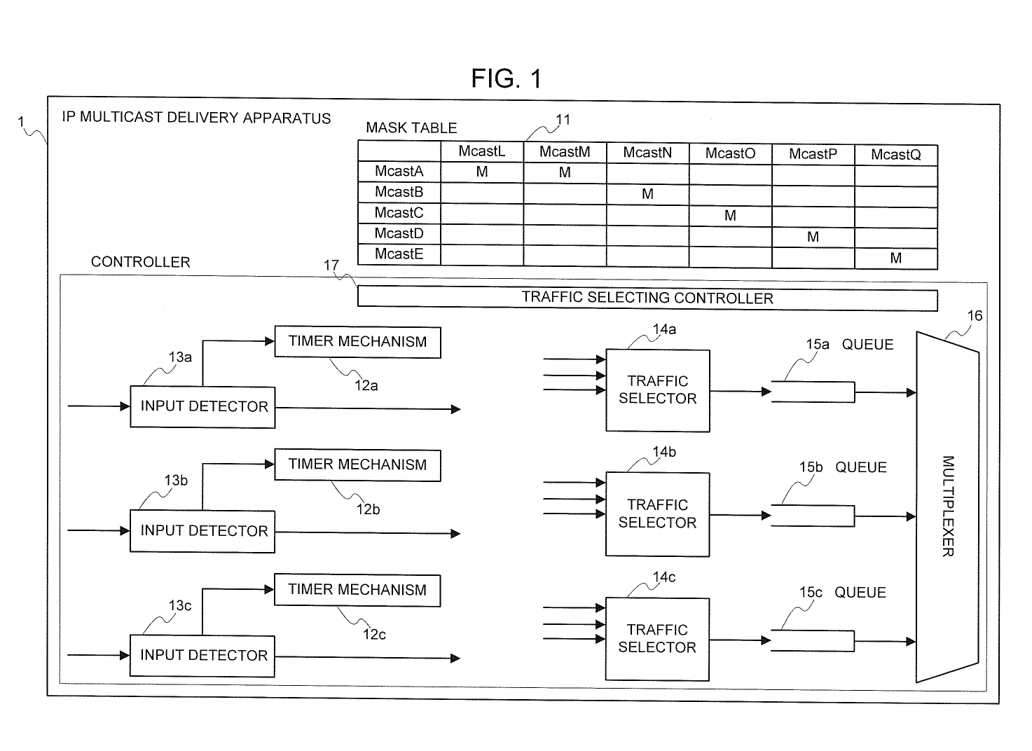

FIG. 1 is a block diagram illustrating a configuration example of the IP (Internet Protocol) multicast delivery apparatus in accordance with the exemplary embodiment of the present invention. In FIG. 1, it is assumed that an IP multicast delivery apparatus 1 is an apparatus in which a distribution technique of the multicast traffic being proposed in the present invention has been installed.

The IP multicast delivery apparatus 1, which is installed in a location point into which the traffic from the multicast delivery server being arranged in a CDN (Content Delivery Network) that is not shown in the figure is input, receives the multicast traffics from a plurality of the multicast delivery servers.

Further, the IP multicast delivery apparatus 1 is configured of input detectors 13a to 13c for detecting a regular input of the traffic, timer mechanisms 12a to 12c, queues 15a to 15c for storing the packet, traffic selectors 14a to 14c for selecting the traffic that is stored into the queue 15a to 15c, respectively, a multiplexer 16 and a traffic selecting controller 17. Each of the queues 15a to 15c, as a rule, has a shaping function etc. for delivering the traffic in an appropriate band in some cases.

It is assumed that the traffic selectors 14a to 14c perform an operation of selecting one multicast traffic from among a plurality of the multicast traffics that were input, or selecting none of them, that is, storing no multicast traffic into the queues 15a to 15c, respectively, based upon an instruction by the traffic selecting controller 17.

In addition hereto, the IP multicast delivery apparatus 1 has a mask table 11 of the multicast traffics. The mask table 11 is defined as data of a plane having a longitudinal axis and a traverse axis, in which the multicast group, which is masked by a certain multicast group, is expressed as a bit map. An example shown in FIG. 1, for example, signifies that when the traffic of a multicast group McastA is input, the traffics of McastL and McastM are masked (indicated with information “M”).

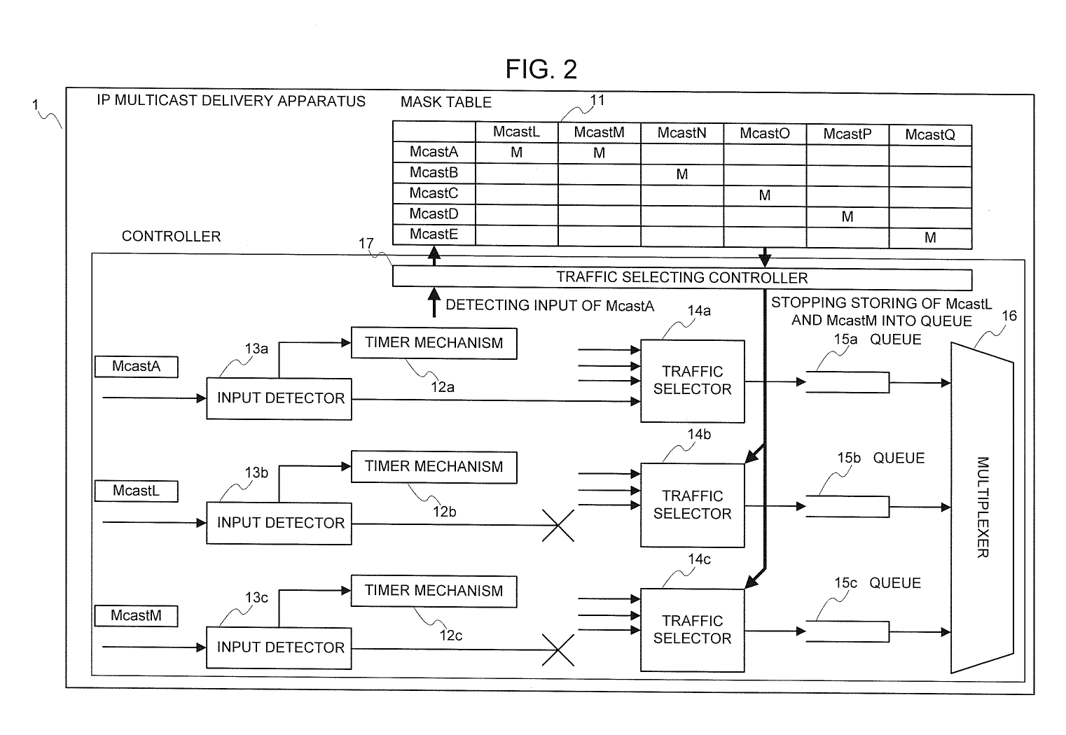

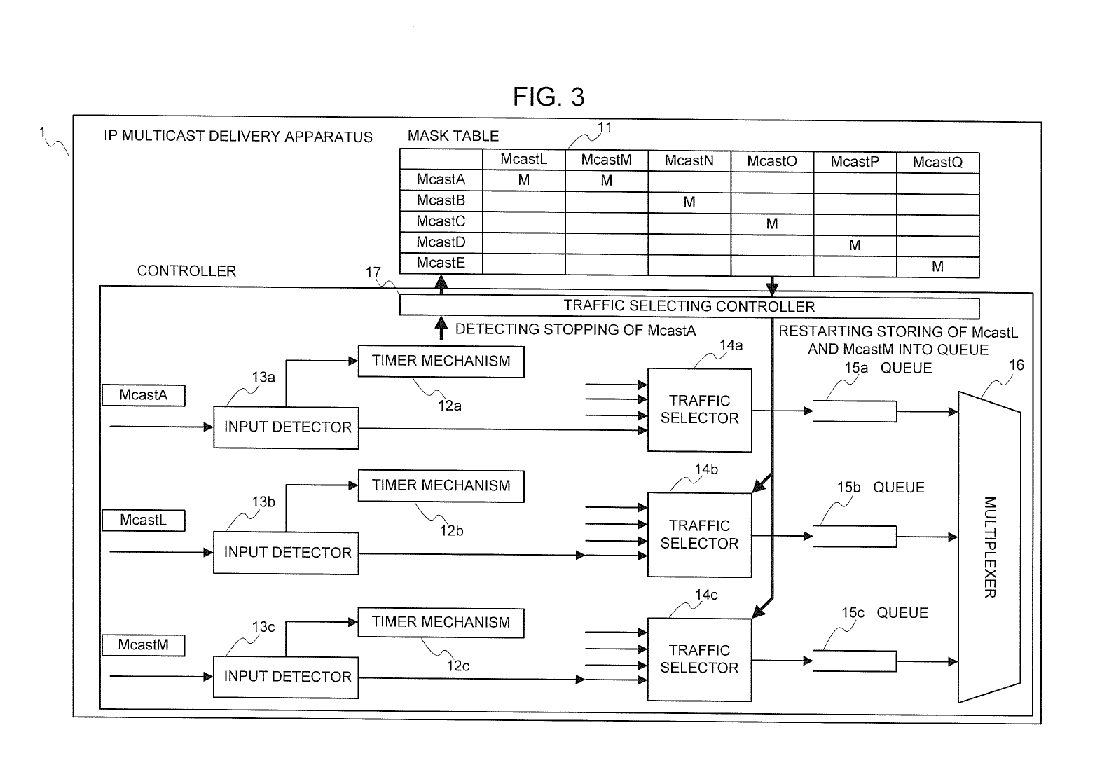

Each of FIG. 2 and FIG. 3 is a view illustrating an operation example of the IP multicast delivery apparatus in accordance with the exemplary embodiment of the present invention. An operation of the IP multicast delivery apparatus 1 in accordance with the exemplary embodiment of the present invention will be explained by making a reference to theses FIG. 1 to FIG. 3.

As shown in FIG. 2, when the input detector 13a and the timer mechanism 12a detect a stabilized input of the traffic, the traffic selecting controller 17 determines the multicast traffics (McastL and McastM) being masked by the traffic (McastA) that was input with the mask table 11. And the traffic selecting controller 17 instructs the traffic selectors 14b and 14c, which correspond to the queues 15b and 15c of the traffics McastL and McastM being masked, respectively, to stop storing of the traffics McastL and McastM based upon this determination.

The traffic selectors 14b and 14c stop storing of traffics McastL and McastM being masked according to the instruction.

Contrarily hereto, as shown in FIG. 3, when the input detector 13a and the timer mechanism 12a cannot detect an input of the McastA traffic for a constant time, the traffic selecting controller 17 gives an instruction for making a switchover of the traffic selectors 14b and 14c that correspond to the multicast traffics (McastL and McastM) masked by the corresponding multicast group (McastA) under control of the mask table 11, and the traffic selectors 14b and 14c restarts storing of the traffic into the queues 15b and 15c, respectively.

With this, in the exemplary embodiment of the present invention, based upon presence or absence of a multicast packet being input into the IP multicast delivery apparatus 1, it becomes possible to stop/restart delivery of the other multicast traffics.

### EXEMPLARY EXAMPLE 1

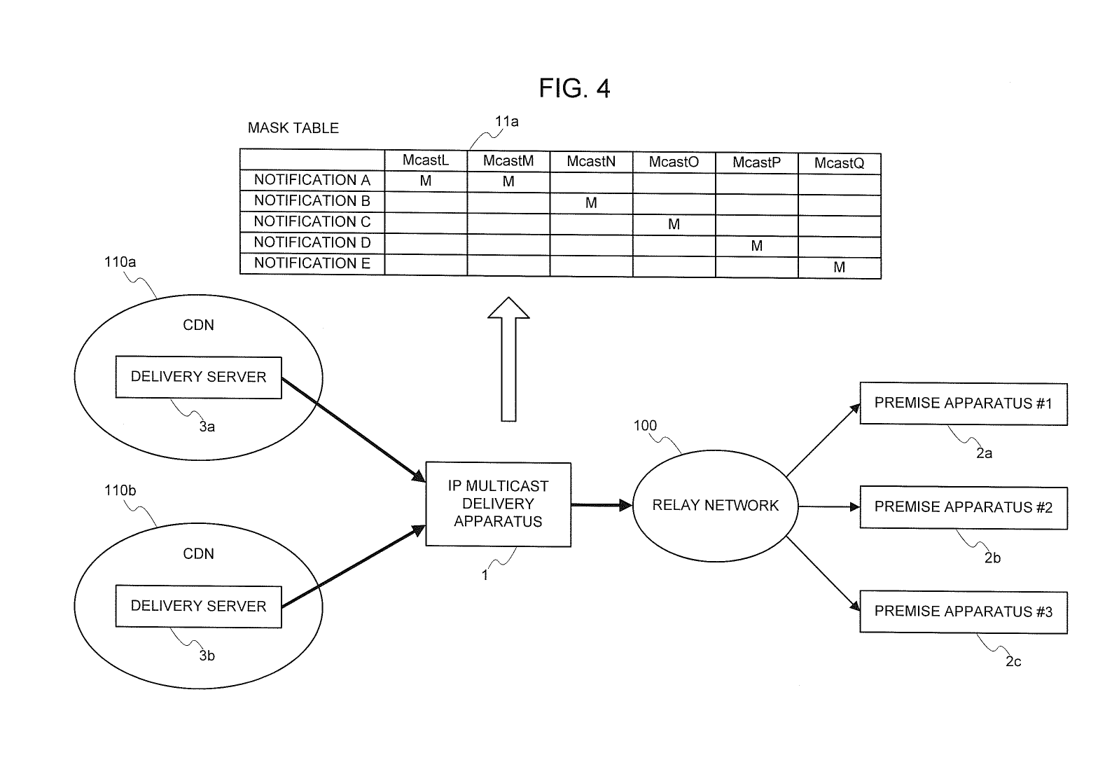

FIG. 4 is a block diagram illustrating a configuration of the content delivery system in accordance with one exemplary example of the present invention. In FIG. 4, the IP multicast delivery apparatus 1 has a master table 11a of the multicast traffics. Further, the IP multicast delivery apparatus 1 has network interfaces each having at least two ports, and some interfaces out of them are connected to a relay network 100 and some out of the remaining interfaces are connected to networks (CDNs) 110a and 110b installed in multicast delivery servers 3a and 3b.

At this moment, the mask table 11a has multicast group addresses for emergency notification (“notification A”, “notification B”, “notification C”, “notification D”, and “notification E”) in a longitudinal-axis side, and addresses (“McastL”, “McastM”, “McastN”, “McastO”, “McastP”, and “McastQ”) of the multicast traffics dynamically delivered with the protocol such as an IGMP (Internet Group Multicast Protocol) in the corresponding network in a traverse-axis direction, respectively.

In the mask table 11a, with the multicast group that is masked by the emergency notification group address in the longitudinal-axis side, a MASK flag (“M”) is set to a box that corresponds hereto. It is assumed that information of the traffic that is masked by the emergency notification traffic is pre-set based upon an area code, band information of the traffic, or the like.

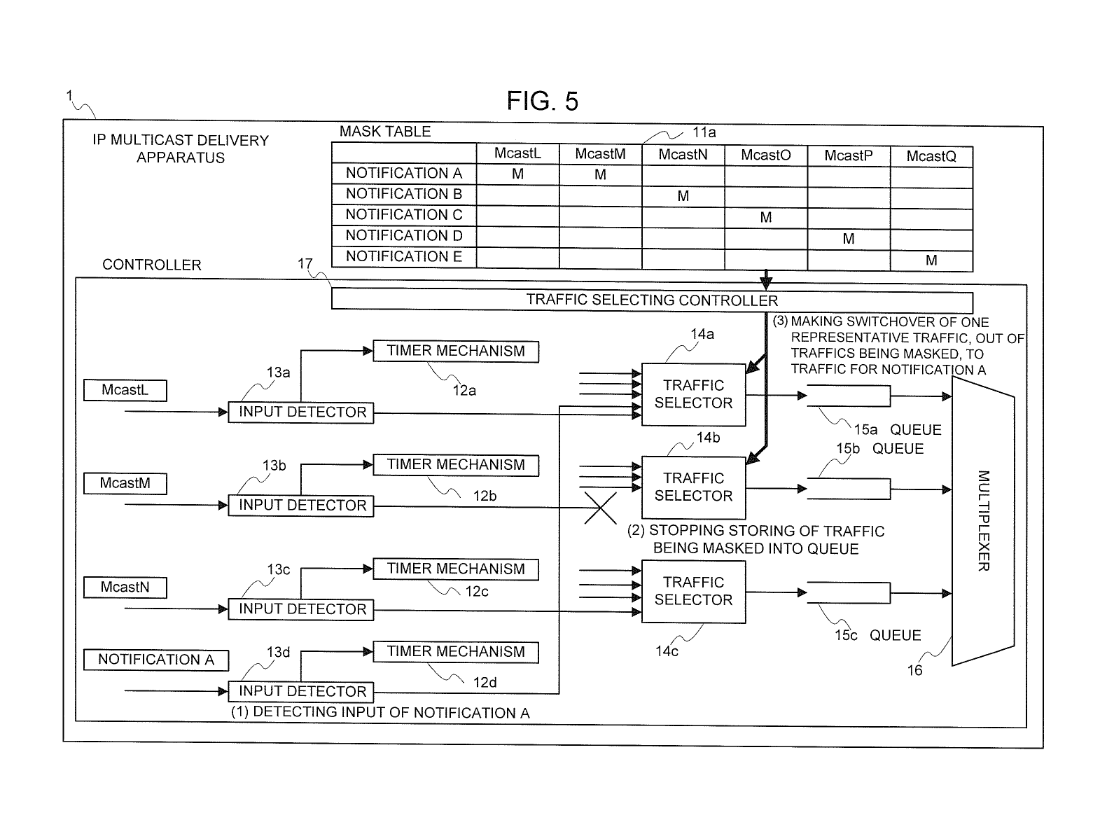

FIG. 5 is a view illustrating an outline of an operation of the packet in the IP multicast delivery apparatus 1 shown in FIG. 4. An outline of an operation of the packet in the IP multicast delivery apparatus 1 will be explained by making a reference to these FIG. 4 and FIG. 5.

At first, in this exemplary example, the multicast traffic that is relayed via the corresponding IP multicast delivery apparatus 1 is recognized with an appropriate protocol process, and the queues 15a to 15c are allotted hereto traffic by traffic. The method of recognizing the multicast traffic that goes through the above IP multicast delivery apparatus 1 is realized by packing a multicast control protocol that is used for the network to which the IP multicast delivery method in accordance with the present invention is applied, or by packing a snooping/proxy function of the corresponding protocol, and explanation of how to realize it is omitted because the method of realization is well known by those of ordinary skill in the art.

Herein, with the multicast control protocol, there exist some protocols, for example, a host-router protocol and a router-router protocol, and in this exemplary example, the multicast control protocol is not limited in particular because the multicast control protocol, which enables the multicast traffic that goes through the above IP multicast delivery apparatus 1 to be recognized and the queues 15a to 15c to be allotted respectively, is acceptable.

In this status, when the multicast packet of an emergency notification A is detected by the input detector 13d and the timer mechanism 12d [process of (1) of FIG. 5], the traffic selecting controller 17 specifies the traffics “McastL” and “McastM”, which are masked with the mask table 11a, with its multicast address assumed to be a key.

The emergency notification broadcast has been set as a special multicast group that is preferentially received in premise apparatuses (#1 to #3) 2a to 2c, whereby the traffic selecting controller 17 gives an instruction for selecting one traffic, out of the traffics (“McastL” and “McastM”) that are masked with the foregoing mask determination, switching the traffic selector that corresponds to its queue to a selector for the emergency notification traffic.

Further, the traffic selecting controller 17 gives an instruction for invalidating the selection of the traffic to the traffic selector 14b that corresponds to the queue 15b of the mask-determined traffics other than it. In an example shown in FIG. 5, with the traffic being switched assumed to be “McastL” and the traffic being stopped to be “McastM”, respectively, upon taking a control of the corresponding traffic selectors 14a and 14b, it follows that the traffic for notification (“Notification A”) is stored into the queue 15a, and no traffic is stored into queue 15b.

With this, in this exemplary example, it follows that the emergency notification traffic is delivered to the premise apparatuses (#1 to #3) 2a to 2c and the normal traffic of which the priority order is lower than the corresponding traffic is not delivered hereto.

In such a manner, in this exemplary example, the multicast traffic being delivered to the premise apparatuses (#1 to #3) 2a to 2c is only a traffic for emergency notification because the normal multicast traffic that is to be delivered to the corresponding area is stopped due to the emergency notification traffic, which enables its emergency notification to be correctly reproduced by the premise apparatuses (#1 to #3) 2a to 2c.

Further, in this exemplary example, the effect as well that the possibility of oppressing the other traffics is eliminated because the normal packet, which is to be delivered to the above area, is stopped due to the emergency notification traffic is obtained.

### EXEMPLARY EXAMPLE 2

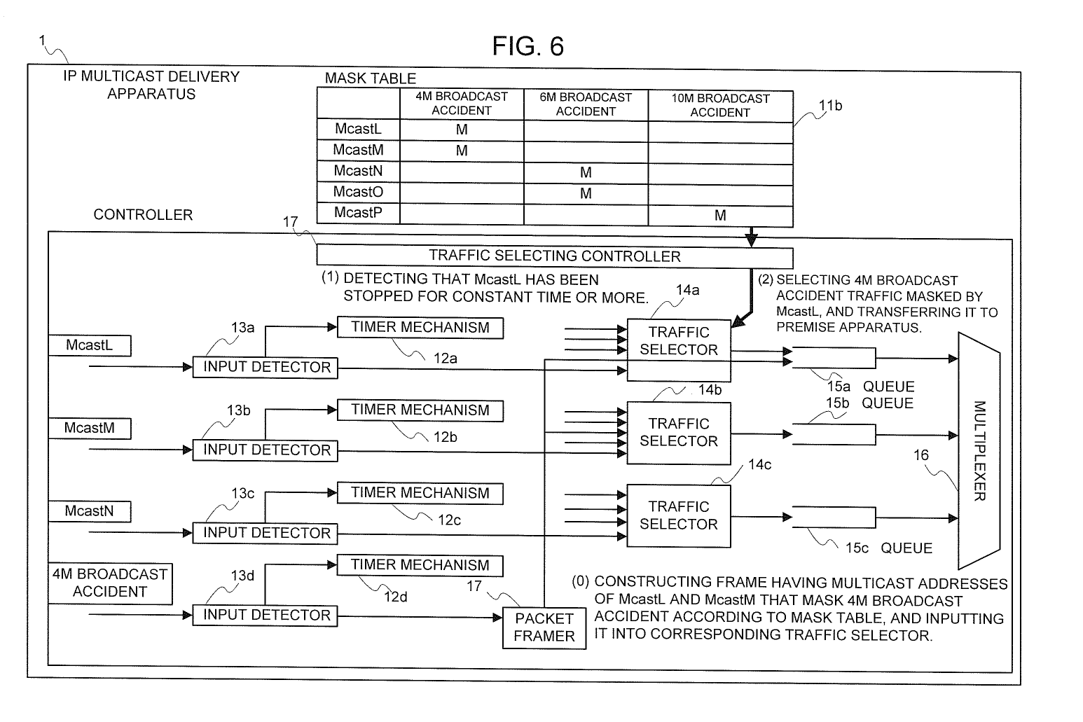

FIG. 6 is a view illustrating an outline of an operation of the packet in the IP multicast delivery apparatus in accordance with another exemplary example of the present invention. In FIG. 6, the IP multicast delivery apparatus in accordance with another exemplary example of the present invention, which is provided with a packet framer 17, assumes a configuration identical to the configuration of the IP multicast delivery apparatus 1 in accordance with one exemplary example of the present invention shown in FIG. 5 except that the content of a mask table 11b differs, and identical code is affixed to an identical component.

In the mask table 11b, multicast addresses (“McastL”, “McastM”, “McastN”, “McastO”, and “McastP”) of the normal multicast traffics, and multicast addresses (“4M broadcast accident”, “6M broadcast accident”, and “10M broadcast accident”) for a broadcast accident are arranged in a longitudinal axis and a traverse axis, respectively, and the setting is made so that the corresponding broadcast accident traffic is masked based upon the band of the multicast traffic.

Further, with the traffic for a multicast accident, the packet framer 17 that becomes a packet editing mechanism for editing a multicast address of the packet and a VLAN (Virtual Local Area Network) is provided between the input detector 13d and the traffic selectors 14a to 14c.

The packet framer 17 edits broadcast accident data according to the multicast group (the multicast address and the VLAN) of the normal multicast traffic that corresponds to the corresponding broadcast accident traffic by the mask table 11b, and transmits the packet to the corresponding traffic selector.

In an example shown in FIG. 6, the 4M broadcast accident traffic is masked by the McastL and the McastM, respectively, whereby the packet framer 17 constructs the packet for the 4M broadcast accident as a packet of the multicast address of McastL and the VLAN, and a packet of the multicast address of McastM and the VLAN, and transmits them to the traffic selectors 14a and 14b that corresponds to McastL and McastM, respectively.

In this status, when the input detector 13a and the timer mechanism 12a detect stopping of the normal multicast traffic McastL, the traffic selecting controller 17 gives an instruction for making a switchover to the broadcast accident traffic (the packet for the 4M broadcast accident) from the multicast traffic McastL to the traffic selector 14a for a purpose of lifting up the mask of the broadcast accident traffic (the packet for the 4M broadcast accident) by the McastL according to the mask table 11b. And the broadcast accident traffic (the packet for the 4M broadcast accident) is stored into the appropriate queue 15a by the traffic selector 14a.

In this exemplary example, in the status where the input of the broadcast accident traffic has become effective due to stopping of the normal traffic, when the fact that the normal multicast traffic has come to be regularly input once again is detected, a switchover of the traffic selector 14a is made once again by the mask table 11b. That is, the input detector 13a and the timer mechanism 12a detect the normal multicast traffic McastL for a constant time, the traffic selecting controller 17 gives an instruction for making a switchover to the multicast traffic McastL from the broadcast accident traffic (the packet for the 4M broadcast accident) to the traffic selector 14a for a purpose of masking the broadcast accident traffic (the packet for the 4M broadcast accident) according to the mask table 11b. And the multicast traffic McastL is stored into the appropriate queue 15a by the traffic selector 14a.

In this exemplary example, this allows the broadcast accident traffic to be masked once again, and the normal multicast traffic to be delivered to the premise apparatus.

In this exemplary example, in such a manner, it becomes possible to notify occurrence of the broadcast accident to the viewer/listener in a case where the traffic has stopped due to the failure of the delivery server, or the network in the delivery server side.

With the emergency broadcast and the broadcast accident in the foregoing two exemplary examples, the former takes priority over the latter. This makes it possible to search two master tables 11a and 11b according to the corresponding priority order, and to make a switchover of the delivery between the emergency broadcast and the broadcast accident by the identical IP multicast delivery apparatus 1.

Likewise, when a plurality of the tables having a priority order exist, selecting and stopping the traffic according to its priority order make it possible to appropriately decide the traffic that is finally delivered.

While the invention has been particularly shown and described with reference to exemplary examples thereof, the invention is not limited to these exemplary examples. It will be understood by those of ordinary skill in the art that various changes in form and details may be made therein without departing from the spirit and scope of the present invention as defined by the claims.

What is claimed is:

1. An IP multicast delivery apparatus for relaying the content, which is delivered from the multicast delivery server with the IP (Internet Protocol) multicast, to the premise apparatus, comprising:
managing unit for managing a dependence relation of the content between the multicast groups; and
controller for stopping/restarting of transfer of a multicast group based on the dependence relation that is managed by said managing unit.

2. The IP multicast delivery apparatus of claim 1, wherein said managing unit comprise a mask table for accumulating a dependence relation of the content between multicast groups.

3. The IP multicast delivery apparatus of claim 2, wherein the multicast group, which is masked by the specific multicast group, is expressed as a bit map in said mask table.

4. The IP multicast delivery apparatus of claim 2, wherein said controller comprises:
input detector for detecting a regular input of the multicast traffic;
queue for storing the multicast traffic;
traffic selector for selecting the multicast traffic that is stored into the queue; and
traffic selecting controller for, at the time that said input detector have detected the stabilized input of the multicast traffic, determining the multicast traffic, which is masked by its multicast traffic that was input, based on said mask table, and instructing said traffic selector to stop a storage of the multicast traffic being masked into the queue.

5. The IP multicast delivery apparatus of claim 2, wherein said traffic selecting controller instructs said traffic selector to restart a storage of the multicast traffic masked by the multicast group into said queue When said input detector cannot detect the input of the multicast traffic for a constant time.

6. The IP multicast delivery apparatus of claim 1,
wherein said specific multicast group signifies an emergency notification traffic, and
said controller stops/restarts the normal multicast traffic that is to be delivered to the corresponding area, base on the presence or absence of said emergency notification traffic.

7. The IP multicast delivery apparatus of claim 1,
wherein said specific multicast group signifies a normal multicast traffic being delivered to the corresponding area, and
said controller stops/restarts the broadcast accident traffic being the another multicast group, base on the presence or absence of said normal multicast traffic.

8. An IP multicast delivery system for relaying the content, which is delivered from the multicast delivery server with the IP (Internet Protocol) multicast, to the premise apparatus, comprising:
managing unit for managing a dependence relation of the content between the multicast groups; and
controller for stopping/restarting of transfer of a multicast group based on the dependence relation that is managed by said managing unit.

9. An IP multicast delivery method for relaying the content, which is delivered from the multicast delivery server with the IP (Internet Protocol) multicast, to the premise apparatus, comprising the steps of:
managing process for managing a dependence relation of the content between the multicast groups; and
controlling process for stopping/restarting of transfer of a multicast group based on said dependence relation that is managed.

10. The IP multicast delivery method of claim 9, wherein said managing process manages said dependence relation using a mask table for accumulating a dependence relation of the content between multicast groups.

11. The IP multicast delivery method of claim 10, wherein the multicast group, which is masked by the specific multicast group, is expressed as a bit map in said mask table.

12. The IP multicast delivery method of claim 10, wherein said controlling process comprises the steps of:
input detecting process for detecting a regular input of the multicast traffic; and
at the time that said the stabilized input of the multicast traffic is detected in said input detecting process, determining the multicast traffic, which is masked by its multicast traffic that was input, with the mask table, and stopping a storage of the multicast traffic being masked with this determination into the queue.

13. The IP multicast delivery method of claim 10, wherein said controlling process restarts a storage of the multicast traffic masked by the multicast group into said queue When the input of the multicast traffic cannot detect for a constant time in said input detecting process.

14. The IP multicast delivery method of claim 9,
wherein said specific multicast group signifies an emergency notification traffic, and
said controlling process stops/restarts the normal multicast traffic that is to be delivered to the corresponding area, base on the presence or absence of said emergency notification traffic.

15. The IP multicast delivery method of claim 9,
wherein said specific multicast group signifies a normal multicast traffic being delivered to the corresponding area, and
said controlling process stops/restarts the broadcast accident traffic being the another multicast group, base on the presence or absence of said normal multicast traffic.
